(19) United States
(12) Patent Application Publication
(10) Pub. No.: US 2019/0059329 A1
(43) Pub. Date: Feb. 28, 2019

(54) ANIMAL TOYS WITH INCORPORATED FLAVOR COMPOSITIONS

(71) Applicant: Logical Brands, Inc., Gardena, CA (US)

(72) Inventors: Lendy Beatty, Playa Del Rey, CA (US); Jeff Spencer, Mason, OH (US)

(21) Appl. No.: 16/118,981

(22) Filed: Aug. 31, 2018

Related U.S. Application Data
(60) Provisional application No. 62/552,586, filed on Aug. 31, 2017.

(51) Int. Cl. A01K 15/02

(52) U.S. Cl. CPC A01K 15/026; B29B 9/06

(57) ABSTRACT

Non-toxic, polymeric animal toys with incorporated flavor compositions are disclosed and described. The flavor compositions are emulsified to provide high flash points which will withstand polymer processing techniques used to form the toys without significant losses of the flavor composition. Exemplary animal toys include those with polymeric foam bodies and elastomers that have flavor emulsions mixed into them as well as semi-crystalline polymeric fiber toys in which the outer fibers and all or part of the core fibers have an incorporated flavor composition.

### CROSS-REFERENCE TO RELATED APPLICATIONS

This application claims the benefit of U.S. Provisional Patent Application No. 62/552,586, filed on Aug. 31, 2017, the entirety of which is hereby incorporated by reference.

### FIELD

The present disclosure relates to animal toys, and more particularly, to animal toys with incorporated flavor compositions.

### BACKGROUND

Dogs have senses of smell that are many thousand times greater than humans. Because of their enhanced sense of smell, toys that produce attractive scents appeal to dogs and result in the dogs engaging them for extended play. Pet obesity has also increased in recent years, making toys that provide a non-caloric means of engaging pets desirable.

To ensure their durability and withstand prolonged chewing while remaining attractive to animals, it would be desirable to provide polymeric animal toys (e.g., balls, rings, bones) comprising incorporated flavor compositions that are “natural flavors,” non-limiting examples of which may include natural flavors such as natural beef, bacon, sweet potato pie, peanut butter, cheddar cheese, or chicken flavors. In preferred examples herein, the natural flavors taste like the flavor name (e.g., chicken, beef, bacon, cheddar cheese, sweet potato pie, peanut butter, etc.) but also have a scent consistent with the flavor to attract the animal to engage with the toy in which it is incorporated. However, such toys are typically formed using polymer mixing and molding processes carried out at conditions that would cause the flavor compositions to flash off, which is wasteful and in many cases yields a toy that does not have a sufficiently strong attractive flavor scent. In many cases, the polymer processing temperatures are too high relative to the flash point of the flavor compositions to allow for direct incorporation of the flavor compositions into the polymer.

In the case of rope toys, it is desirable to form the toy from polymeric fibers and provide a long-lasting, thermally stable flavor composition on and/or in the fibers to ensure that the fibers dry in a desirable time frame after prolonged exposure to animal saliva. Thus, a need has arisen for animal toys and processes of making the same which address the foregoing issues.

### BRIEF DESCRIPTION OF THE DRAWINGS

The disclosure will now be described, by way of example, with reference to the accompanying drawings, in which:

FIG. 1 is front perspective view of a polymer foam crunch ball animal toy with an incorporated flavor composition;

FIG. 2 is a front elevational view of a polymer foam bounce ball animal toy with an incorporated flavor composition;

FIG. 3A is a front elevational view of a polymer foam pebble chew animal toy with an incorporated flavor composition;

FIG. 3B is a rear elevational view of the pebble chew animal toy of FIG. 3A;

FIG. 4 is a top plan view of a rubber ring animal toy with an incorporated flavor composition;

FIG. 5A is a top plan view of a rubber bone animal toy with an incorporated flavor composition;

FIG. 5B is perspective view of the rubber bone toy of FIG. 5A;

FIG. 5C is longitudinal cross-sectional view of the rubber bone toy of FIG. 5A showing the core layer and the overmold layer;

FIG. 6 is a side elevation view of rubber ball animal toy with an incorporated flavor composition;

FIG. 7 is a front elevation view of a shaped polymeric fiber tug toy with a flavor composition;

FIG. 8 is a front elevation view of a shaped polymeric fiber rope stick toy with a flavor composition;

FIG. 9 is a front elevation view of as shaped polymeric fiber “monkey fist” toy comprising a flavor composition;

FIG. 10 is a flow chart illustrating a method of making a non-toxic polymeric foam animal toy having an incorporated flavor composition;

FIG. 11 is a flow chart illustrating a method making a dual layer, non-toxic elastomeric animal toy having an incorporated flavor composition;

FIG. 12 is a flow chart illustrating a method of making a non-toxic, braided polymeric fiber toy having an incorporated flavor composition;

FIG. 13 is an illustrative depiction of an animal toy with an emulsified flavor composition incorporated therein;

FIG. 13A is a close-up view of a portion of FIG. 13;

FIG. 14A is an illustrative depiction of a semi-crystalline polymer used to form an animal toy to prior to incorporation of a flavor;

FIG. 14B is an illustrative depiction of the infusion of a flavor compound into the amorphous regions of the semi-crystalline polymer of FIG. 14A when the polymer is immersed in a bath containing the flavor compound at a temperature between the polymer's glass transition temperature T_{g} and melting point Tₘ;

FIG. 14C is an illustrative depiction of the flavor infused animal toy of FIG. 14B when the polymer is below its glass transition temperature T_{g}; and

FIG. 15 is a graph depicting the volume of the semi-crystalline polymer of FIG. 14A as a function of temperature.

### DETAILED DESCRIPTION

The present disclosure relates to non-toxic polymeric animal toys that include a flavor composition. In a first aspect of the present disclosure, an animal toy is provided which comprises a non-toxic polymeric body having a flavor composition incorporated therein. In certain preferred examples, the flavor composition is provided in the polymeric matrix of the polymeric body, i.e., through the continuous polymer phase. In a second aspect, an animal toy comprising a plurality of non-toxic, braided polymeric fibers is provided, wherein the animal toy has a core section of fibers and an outer section of fibers, and the animal toy further comprises a flavor composition in the outer section and at least a part of the core section. In certain preferred examples, the polymeric core fibers comprise semi-crystalline polymer fibers, such as polyesters and polyamide fibers, examples of which include polyethylene terephthalate, polybutylene terephthalate, and poly(hexamethylene adipamide) fibers, and the flavor composition is absorbed in and/or coated on the fibers. In the same or other examples, the outer section comprises semi-crystalline polymer fibers that have a greater wicking capability (as defined herein) relative to core fibers' wicking capability.

It has been found that by incorporating flavor compositions into an emulsified system, the system can be formulated to have a flash point sufficient to withstand polymer processing temperatures that would otherwise degrade the flavor composition alone. The flash point of the flavor emulsion is preferably such that when the polymer used to form the toy is combined with the flavor emulsion, a homogeneous system is obtained that is able to withstand the elevated temperatures and processing times used to make the toy. In examples herein, such elevated temperatures and processing times are at least 165° C. for a period of at least 10 minutes or longer. Accordingly, in preferred examples herein, the flavor compositions used in the animal toys described herein are provided as high flash point, emulsified flavor systems to facilitate their incorporation into the polymeric toy bodies and fibers. In certain examples, the flavor system comprises a flavor composition, a solvent, and a separate emulsifying agent. In other examples, the flavor system comprises a flavor composition and solvent, wherein the flavor composition includes an emulsifying agent as part of the composition. In certain examples, the flavor composition comprises, and preferably consists of, “natural flavors,” as defined in the April 2017 Revision of 21 C.F.R. 101.22(a)(3). However, the flash points of many natural flavors make them unsuitable for direct incorporation into a polymeric toy. Thus, in preferred examples, the natural flavors are provided as part of a flavor emulsion that includes the natural flavors. As used herein, the term “emulsion” refers to a liquid system in which one liquid (the “dispersed phase”) is dispersed in another liquid (the “continuous phase”).

In certain examples, the dispersed phase is the flavor composition, and the continuous phase is a solvent, such as one or more carboxylic acid triglyceride esters. In other examples (known as “reverse emulsions”), the dispersed phase is the solvent and the continuous phase is the flavor composition. In preferred examples, the flavor emulsions are “natural,” which as defined herein means that each ingredient thereof is a plant, animal, or mineral derivative that has not undergone chemical modification. As explained above, the terms “natural flavor” or “natural flavors” refer to the definitions provided in the April 2017 Revision of 21 C.F.R. 101.22(a)(3). Exemplary flavor compositions suitable for the animal toys described herein include food flavors such as beef, chicken, peanut butter, cheddar cheese, sweet potato pie, and bacon natural flavor compositions. However, other natural flavors and flavor systems may be used.

The solvent component of the flavor emulsions described herein is one or more natural, organic compounds. The solvents include carboxylic acid triglyceride esters. Suitable exemplary carboxylic acid triglyceride esters include triacetin and medium chain triglyceride compounds. In certain cases, the flavor composition and the solvent form an emulsion when combined in selected concentrations without the need of a separate emulsifying agent. However, in other cases, a separate emulsifying agent is combined with the solvent and the flavor composition. Such separate emulsifying agents include mixed esters of glycerin, such as those in which one or more of the hydroxyl groups of glycerin has been esterified by diacetyl tartaric acid and by fatty acids to yield a diacetyl tartaric acid ester of mono and diglycerides, commonly known as “DATEM.” DATEM is a natural esterifying agent.

In certain examples, the non-toxic polymeric body is a polymeric foam, and in certain preferred examples is an ethylene vinyl acetate (EVA) copolymer foam. In other examples, the non-toxic polymeric body is an elastomer, and in certain preferred examples, is a natural latex rubber. In preferred examples, the flavor composition is formulated to give off the scent of a food flavor such as beef, chicken, bacon, peanut butter, cheddar cheese, or sweet potato pie when incorporated into the EVA copolymer foam or rubber.

In preferred examples, the animal toy (i.e., including both the polymeric body or fibers and the flavor emulsion) is non-toxic. As used herein, the term “non-toxic”, as it pertains to an animal toy or component thereof, means that no compound on the list of “Chemicals of High Concern for Children (CHCC)” in the State of Washington (as defined by the Revised Code of Washington, Chapter 70.240.040 and the Washington Administrative Code chapter 173-334) is present in an amount greater than the detection limit of 30 ppm by weight of the animal toy or component thereof, respectively. In preferred examples, the flavor emulsion consists exclusively of ingredients registered with FEMA GRAS (Flavor & Extract Manufacturers Association and Generally Regarded as Safe). In certain examples, the animal toy complies with Intertek Pet Toy Test Protocol ITS-08001-US, Version 11 and/or Intertek Toy Test Protocol ITS-16001-US, Version 23.0. In the same or other preferred examples, the animal toy complies with the Consumer Product Safety Improvement Act (CPSIA) and/or California Proposition 65.

In the same or other preferred examples, the ingredients in the flavor composition portion of the flavor emulsion are selected to be compliant with the 2017 Official Publication (OP) of the Association of American feed Control Officials (AAFCO). In other preferred examples, the flavor emulsion is formulated to have a flash point that is close enough to (or in excess of) the polymer processing temperatures (e.g., mixing and molding temperatures) to yield a finished toy with a desirable amount of flavor scent emanating from it prior to being bitten by an animal or otherwise disrupted. The flash point is preferably no less than 80° C., more preferably no less than 85° C., even more preferably no less than 90° C., and still more preferably no less than 94° C.

Each of the animal toys described herein includes a flavor composition. In the case of the polymeric foams and elastomeric toys described below, the flavor composition is preferably distributed in the polymeric matrix. The flavor composition is preferably FEMA GRAS compliant and consists exclusively of all natural ingredients. As mentioned above, the flavor compositions are preferably provided as flavor emulsions and include a solvent that consists of one or more natural, organic compounds, such as medium chain triglycerides or triacetin, which are carboxylic acid triglyceride esters. Triacetin is a glycerol molecule that has been esterified with three acetic acid molecules. MCTs comprise a group of triglycerides having three medium chain length (about 6-12 carbon) fatty acid molecules esterified to a glycerol molecule. In one example, the continuous phase consists essentially of or consists of a mixture of decanoyl and octanoyl glycerides (which are species of MCTs in which glycerol molecules have been esterified with one or two decanoic acid or octanoic acid molecules).

Without wishing to be bound by any theory, it is believed that providing the flavor compositions described herein in the form of an emulsion, effectively raises the flash point of the flavor composition to that of the emulsion (which is relatively higher). The higher flash point prevents the flavor composition from flashing off during the polymer processing steps (e.g., mixing of ingredients and molding) used to form the animal toy. The emulsions comprise a continuous phase and a dispersed phase. In certain examples, a solvent (e.g., MCTs) is the continuous phase, and the flavor composition is the dispersed phase. In other examples (referred to as “reverse emulsions” herein) the flavor composition is the continuous phase and the solvent is the dispersed phase. The flash point of the flavor emulsion is preferably such that when the polymer used to form the toy is combined with the flavor emulsion, a homogeneous system is obtained that is able to withstand the elevated temperatures and processing times used to make the toy. In examples herein, such elevated temperatures and processing times are at least 165° C. for a period of at least 10 minutes or longer.

When used as a solvent in the exemplary flavor emulsions herein, the MCTs comprise the continuous phase and may vary with the type of flavor being used. In general for the flavors described herein, when MCTs are used as the solvent, they are provided in amounts of at least about 20 percent, preferably at least about 25 percent, and more preferably at least about 30 percent by weight of the emulsion.

In certain examples herein, triacetin is used as the solvent and comprises the dispersed phase, with a bacon flavor composition comprising the continuous phase. In accordance with such examples, triacetin is present in an amount ranging from about 0.5 to about 10 percent, preferably from about 0.7 to about 8 percent, and more preferably from about 1 to about 5 percent. The relative concentrations of flavor composition and solvent are preferably selected to maximize the amount of flavor composition while at the same time preserving the emulsified nature of the combined liquids (i.e., while not “breaking” the emulsion) and achieving a high enough flash point to survive the polymer processes used to form the toys.

In certain examples, and in particular, in certain examples involving beef, bacon, cheddar cheese, peanut butter, and sweet potato pie flavor compositions herein, the flavor emulsion also preferably includes a separate emulsifying agent. Suitable emulsifying agents include mixed esters of glycerin, and more preferably mixed esters of glycerin in which one or more of the glycerin hydroxyl groups has been esterified by diacetyl tartaric acid and by fatty acids resulting in a diacetyl tartaric acid of mono and diglycerides. One suitable emulsifying agent is a plant-based (derived from plant sources) diacetyl tartaric acid of mono and diglycerides, commonly known as DATEM in the art. Where the emulsifying agent is used, its preferred concentration may vary with the flavor.

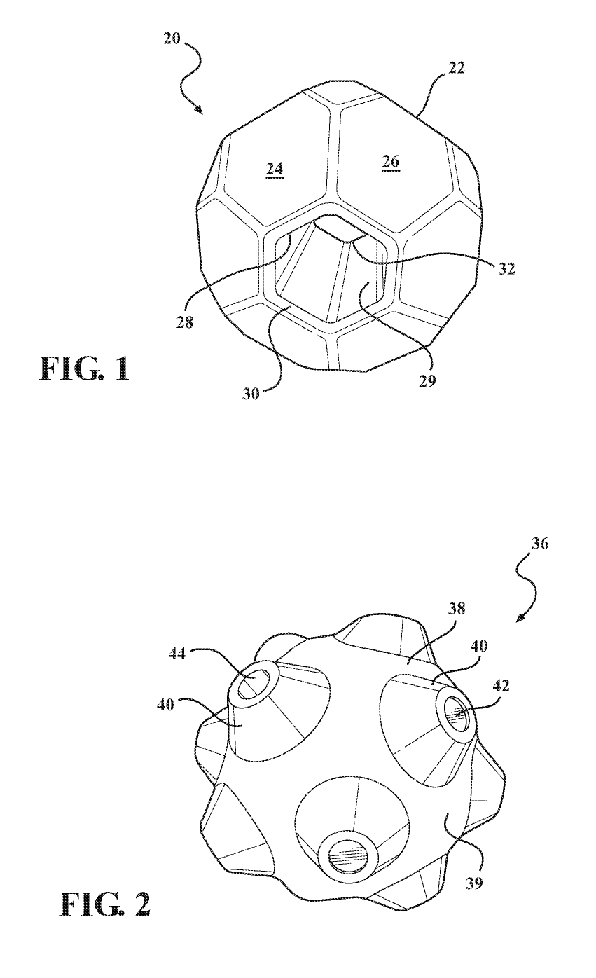

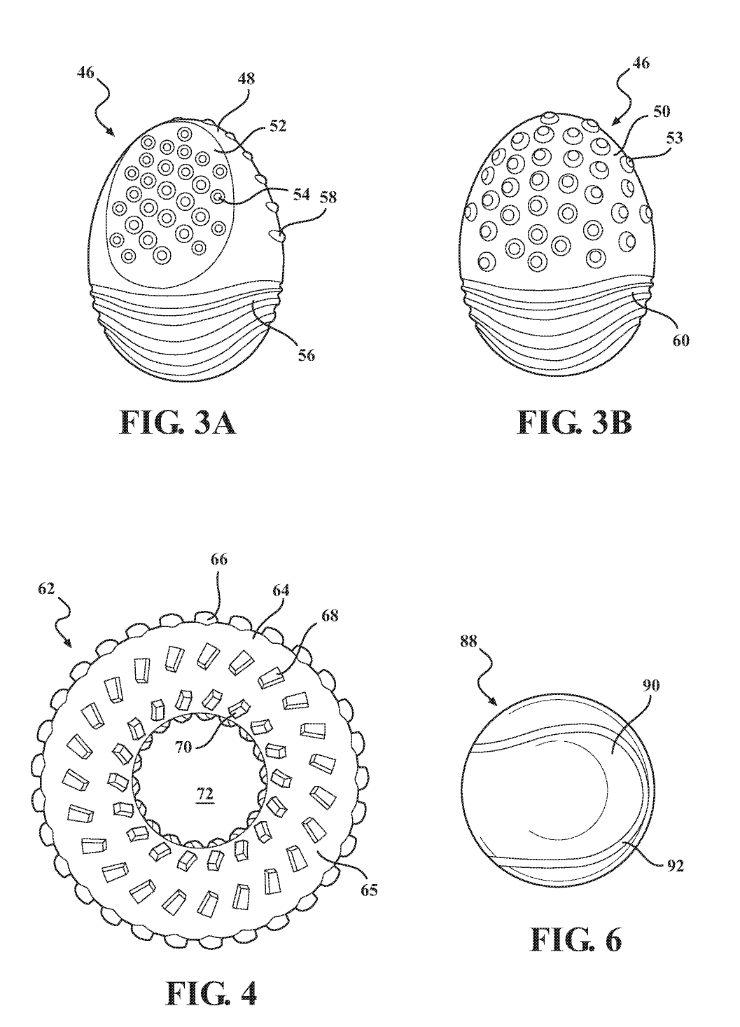

Referring to FIGS. 1-3B, a variety of different animal toys are shown, including a crunch ball 20 (FIG. 1), a bounce ball 36 (FIG. 2), and a pebble chew 46 (FIGS. 3A and 3B). Each of the depicted animal toys 20, 36, and 46 comprises a polymeric body 22, 38 and 48, respectively, and a flavor composition incorporated in the polymeric body 22, 38, and 48.

The polymeric body 22, 38, 48 is preferably a polymeric foam body. The amount of flavor composition in the each toy 20, 36, and 46 is selected to ensure that the toy gives of a human-detectable flavor scent prior to the toy being bitten or otherwise disrupted.

In certain examples, the polymeric foam is formed from a foam precursor that is a copolymer of an alpha-olefin and an ester of a mono-unsaturated carboxylic acid. Ethylene is a preferred alpha-olefin and vinyl acetate is a preferred ester of a mono-unsaturated carboxylic acid. The foam animal toys 20, 36, and 46 are preferably designed to allow and withstand biting and aggressive engagement by a pet and are designed to have an appropriate hardness. In certain examples, the animal toys 20, 36, and 46 have a shore A hardness of from about 40 to about 60 durometer, preferably from about 45 to about 65 durometer, and more preferably from about 48 to about 62 durometer. In one specific example, a Shore A hardness of 50 durometer is used.

In certain examples, the polymeric body is formed from an EVA copolymer. EVA copolymer foams are beneficial for some animal toys because they engage play with the intent that the animal can puncture, but not tear, the polymeric body. In certain examples, suitable EVA copolymers have a melt flow rate in accordance with ISO1131-1 (2.16 kg/190° C.) of from about three to about eight grams/10 minutes, preferably from about five to about seven grams/10 minutes, and even more preferably from about 5.5 to about 6.5 grams/10 minutes.

In the same or other examples, the polymeric body is formed from an EVA copolymer having vinyl acetate units that comprise from about 20 percent by weight to about 30 percent by weight, more preferably from about 24 percent by weight to about 28 percent by weight, and still more preferably from about 25 percent by weight to about 27 percent by weight. A suitable commercially available EVA copolymer is BASF V6110M. BASF V6110M has a melt flow rate in accordance with ISO1131-1 (2.16 kg/190° C.) of six and a vinyl acetate content of 26 percent by weight.

The animal toys 20, 36, and 46 also preferably include an incorporated flavor composition which is provided as a flavor emulsion. In the case of the toys comprising non-toxic, polymeric foam bodies and the flavors described herein, the amount of the flavor emulsion added to the polymer in forming the toy by weight of the toy is from about 1.5 to about 4.0 percent, preferably from about 2.0 to about 3.5 percent, and more preferably from about 2.5 to about 3.0 percent. The amount of the flavor composition by weight of the toy is from about 0.045 to about 3.0 percent, preferably from about 0.1 to about 2.5 percent, and more preferably from about 0.15 to about 2.2 percent by weight.

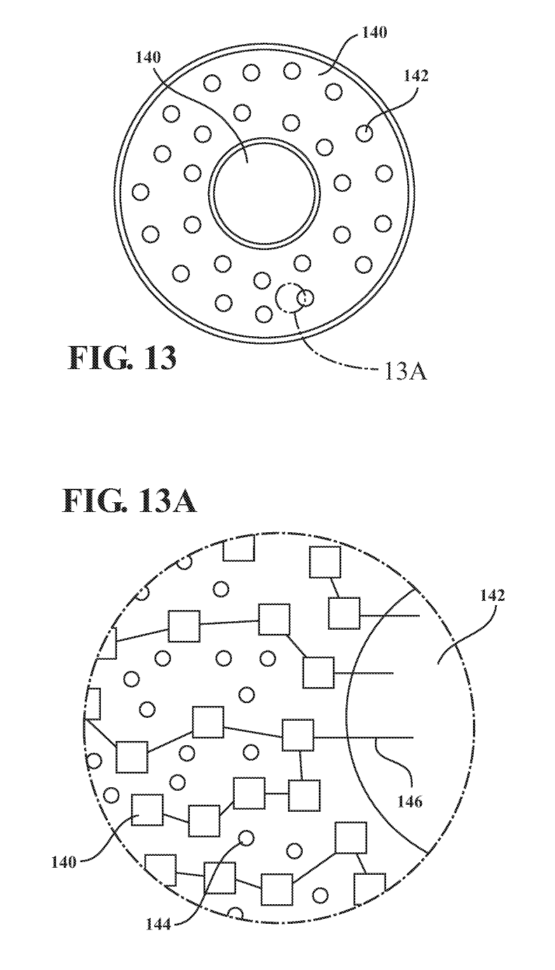

Referring to FIGS. 13 and 13A, an illustration of a toy 140 with an incorporated flavor emulsion is depicted. Polymer chains 141 (e.g., EVA copolymer) define the polymer matrix that is the base material comprising the toy 140. Droplets of solvent 142 (e.g., MCTs) are each bonded to the polymer chains 141 via emulsifier 146 (e.g., DATEM), with flavor molecules 144 distributed between the polymer chains 141.

In certain examples of toys 20, 36, and 46 with an incorporated flavor emulsion comprising a peanut butter flavor composition, the peanut butter flavor composition by weight of the emulsion is preferably from about 20 percent to about 35 percent, preferably from about 22 percent to about 32 percent, and more preferably from about 24 percent to about 29 percent. In the same or other examples, the emulsion comprises a solvent that comprises medium chain triglycerides in an amount by weight of the emulsion ranging from about 60 percent to 80 percent, preferably form about 65 percent to about 75 percent, and more preferably from about 68 percent to about 73 percent. A DATEM emulsifier is preferably present in a non-zero amount by weight of the emulsion that is no more than about five percent, preferably not more than about four percent, and more preferably no more than about two percent.

In certain examples of toys 20, 36, and 46 with an incorporated flavor emulsion comprising a cheddar cheese flavor composition, the cheddar cheese flavor composition by weight of the flavor emulsion is from about 55 percent to about 75 percent, preferably from about 60 percent to about 70 percent, and more preferably from about 62 percent to about 67 percent. In the same or other examples, the flavor emulsion solvent preferably comprises medium chain triglycerides present in an amount by weight of the emulsion ranging from about 20 percent to about 45 percent, preferably from about 25 percent to about 40 percent, and more preferably from about 30 to about 35 percent. A DATEM emulsifier is preferably present in a non-zero amount by weight of the emulsion of not more than about five percent, preferably not more than about four percent, and more preferably not more than about two percent.

In certain examples of toys, 20, 36, and 46 with an incorporated flavor emulsion comprising a sweet potato pie flavor composition, the sweet potato pie flavor composition by weight of the flavor emulsion is from about 5 percent to about 15 percent, preferably from about 6 percent to about 14 percent, and more preferably from about 8 percent to about 13 percent. In the same or other examples, the solvent is preferably a combination of triacetin and medium chain triglycerides. The medium chain triglycerides are preferably present in an amount by weight of the emulsion ranging from about 65 percent to about 90 percent, preferably from about 70 percent to about 85 percent, and more preferably from about 75 percent to about 80 percent. Triacetin is present in an amount by weight of the emulsion ranging from about five percent to about fifteen percent, preferably from about six percent to about fourteen percent, and more preferably from about 7 to about 12 percent by weight of the emulsion. A DATEM emulsifier is preferably present in a non-zero amount by weight of the emulsion of not more than about five percent, preferably not more than about four percent, and more preferably not more than about two percent.

For flavor compositions comprising beef flavors used in the polymeric foam toys herein, the amount of the beef flavor composition by weight of the flavor emulsion is preferably from about 3 percent to about 20 percent, preferably from about 5 percent to about 17 percent, and more preferably from about 6 percent to about 15 percent. At the same time, the amount of medium chain triglyceride solvent ranges from about 65 percent to about 90 percent, preferably from about 70 percent to about 85 percent, and more preferably from about 76 percent to about 81 percent. In the same or other examples, a DATEM emulsifying agent is present in an amount by weight of the emulsion which ranges from about 3 percent to about 16 percent, preferably from about 5 percent to about 13 percent, and more preferably from about 7 percent to about 12 percent. In certain examples, a flavor protecting agent, alpha tocopherol, is also present in a non-zero amount of not more than 0.01 percent by weight of the emulsion.

For flavor compositions comprising chicken flavors used in the polymeric foam toys herein, the amount of the chicken flavor composition by weight of the flavor emulsion ranges from about 10 to about 25 percent, preferably from about 12 to about 22 percent, and more preferably from about 14 to about 19 percent. At the same time, the amount of medium chain triglyceride solvent ranges from about 70 to about 90 percent, preferably from about 75 percent to about 88 percent, and more preferably from about 80 percent to about 85 percent. In the same or other examples, no separate emulsifying agent is used.

For certain flavor compositions comprising bacon flavors used in the polymeric foam toys herein, the amount of the bacon flavor composition by weight of the flavor emulsion ranges from about 12 percent to about 26 percent, preferably from about 15 percent to about 24 percent, and more preferably from about 17 percent to about 22 percent. At the same time, the amount of medium chain triglyceride solvent ranges from about 55 percent to about 85 percent, preferably from about 60 percent to about 80 percent, and more preferably from about 67 percent to about 72 percent. In the same or other examples, a DATEM emulsifying agent is present in an amount by weight of the emulsion which ranges from about 3 percent to about 16 percent, preferably from about 5 percent to about 13 percent, and more preferably from about 7 percent to about 12 percent.

In other exemplary flavor compositions comprising bacon, a bacon flavor composition is provided as a reverse emulsion, i.e., with a solvent that forms the dispersed phase in a continuous phase of the bacon flavor composition. In accordance with one example, a triacetin solvent is provided in amounts by weight of the reverse emulsion ranging from about 0.5 to about 10 percent, preferably from about 0.7 to about 7 percent, and more preferably from about one to about 5 percent. In accordance with such examples, the bacon flavor composition is provided in an amount by weight of the reverse emulsion ranging from about 90 percent to about 99.8 percent, preferably from about 92 to about 99.6 percent, and more preferably from about 94 to about 99 percent.

Referring to FIG. 1, a crunch ball 20 in accordance with the first aspect is depicted. Crunch ball 20 comprises a polymeric foam body 22 that is preferably formed from a non-toxic foam precursor comprising a copolymer of an alpha-olefin and an ester of a mono-unsaturated carboxylic acid, such as EVA. A flavor emulsion of the type described above (i.e., consisting of a flavor compound, a solvent, and in the case of beef flavors, peanut butter, cheddar cheese, and sweet potato pie, an emulsifying agent) is preferably incorporated in the polymeric foam body 22, and more preferably within the polymeric matrix, during mixing and/or molding steps used to form the crunch ball 20. The flash point of the flavor emulsion is preferably no less than 80° C., more preferably no less than 85° C., even more preferably no less than 90° C., and still more preferably no less than 94° C.

The body 22 has a surface comprising planar facets, for example, planar facets 24 and 26. Only two facets are identified with reference numerals. Facets 24 and 26 define a hexagonal shape, but are oriented at an obtuse angle with respect to one another. The other pairs of facets around the surface of the body 22 are configured similarly. Opening 28 is configured as a hexagonal through-opening from one side of the crunch ball 20 to the other and has a first end 30 and a second end 32 spaced apart from one another along an axis extending through the center of crunch ball 20. The through-opening 28 allows the crunch ball to deform in a radially inward direction when bitten by a pet. Ridges 29 are provided within crunch ball 20 and create a noise when crunch ball 20 is compressed to further engage the animal. Other than the through-opening 28, the body 22 is preferably solid polymeric foam throughout.

Referring to FIG. 2, a polymeric foam bounce ball 36 is depicted. The materials used to form polymeric foam bounce ball 36 may be the same as those used to form crunch ball 20. Bounce ball 36 comprises a polymeric foam body 38 having a flavor composition incorporated in it. In preferred examples, the flavor composition is provided as a flavor emulsion of the type described previously. The flash point of the flavor emulsion is preferably no less than 80° C., more preferably no less than 85° C., even more preferably no less than 90° C., and still more preferably no less than 94° C.

The bounce ball 36 has a generally spherical surface 39 and a plurality of projections 40 spaced around the bounce ball 36. In certain examples, the projections 40 are evenly distributed and spaced apart around the spherical surface 39. In the same or other examples, the projections 40 each have a frustoconical shape, as illustrated in FIG. 2. The frustoconical projections 40 cause the bounce ball 36 to bounce in a greater variety of directions when thrown depending on the number of projections 40 that make contact with the surface from which the bounce ball 36 bounces and/or the angle of impact between the frustoconical projections 40 and the surface. Certain of the projections 40 may have openings 44 and others have a closed end 42. With respect to the depicted bounce ball 35, other than certain openings in the projections 40, the body 38 and the projections 40 are preferably solid polymeric foam throughout. However, hollow bounce balls and other hollow EVA toys may also be used.

A pebble chew 46 is depicted in FIGS. 3A and 3B. Pebble chew 46 is generally ovular or egg shaped. Pebble chew 46 has a first side 48 shown in FIG. 3A and an opposing side 50 shown in FIG. 3B. The first side (FIG. 3A) includes a generally planar facet 52 having a plurality of bosses 53 projecting away from the facet 52. The second side (FIG. 3B) includes surface 50 and bosses 53 projecting away from surface 50. Circumferential grooves 56 (FIG. 3A) and 60 (FIG. 3B) are also provided. Pebble chew 46 preferably comprises polymeric foam throughout with an incorporated flavor composition provided as a flavor emulsion of the type described with respect to the crunch ball 20 and bounce ball 36. The flash point of the flavor emulsion is preferably no less than 80° C., more preferably no less than 85° C., even more preferably no less than 90° C., and still more preferably no less than 94° C.

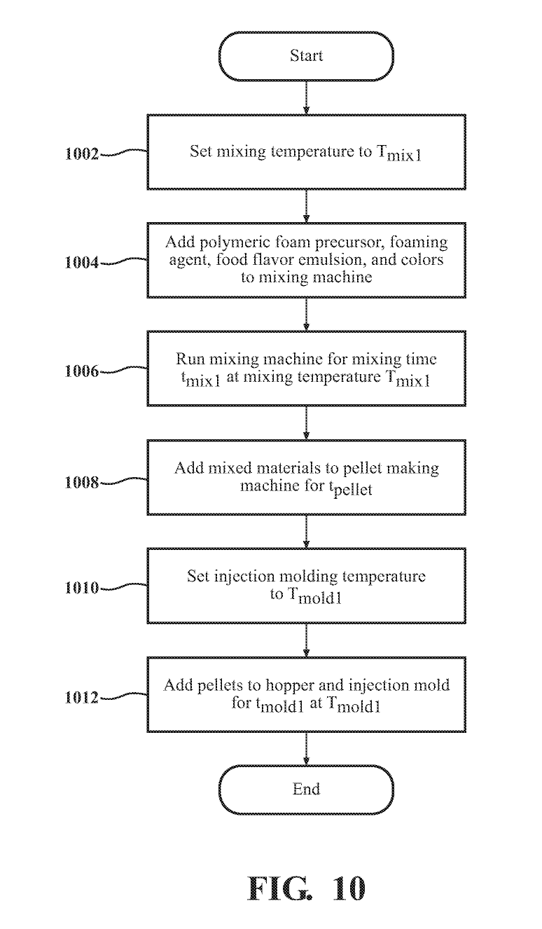

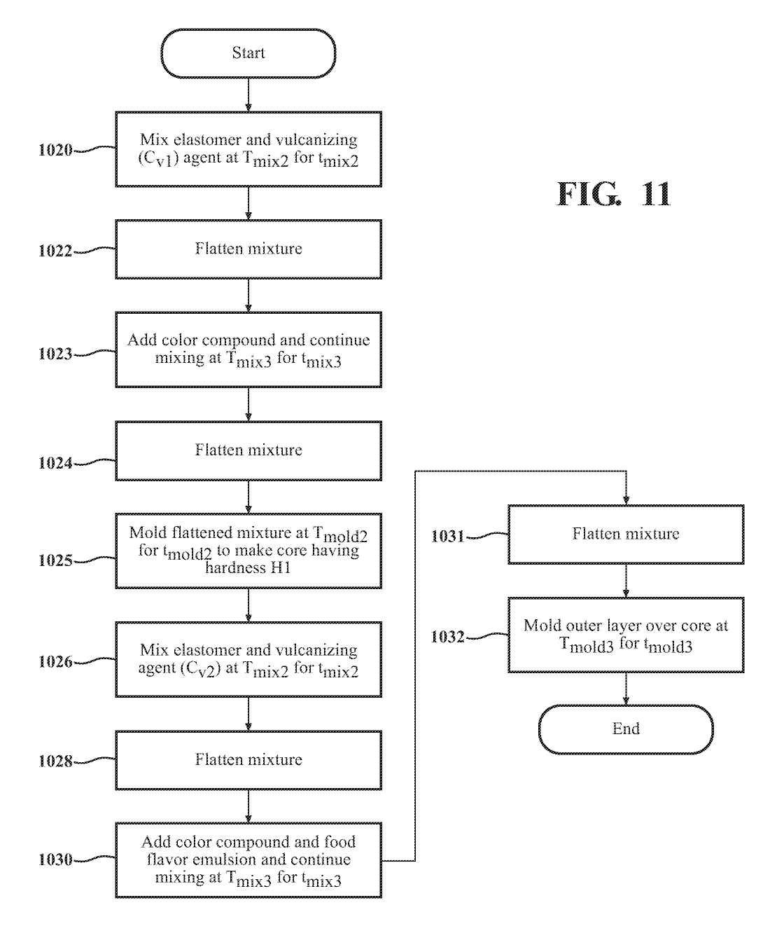

Referring to FIG. 10 a method of making the polymeric foam animal toys 20, 36, and 46 will now be described. In step 1002 a temperature-controlled mixer is provided and a mixing temperature is set at a mixing temperature Tₘᵢₓ₁. The value of Tₘᵢₓ₁ is preferably set to ensure that the polymeric foam precursor used to form the polymeric body 22, 38, 48 is sufficiently soft to allow the flavor composition to be incorporated in it. Preferably, the flavor composition may be distributed throughout the polymeric body 22, 38, 48. The animal toys 20, 36, and 46 preferably include flavor compositions, such as flavor compositions selected from beef, chicken, cheddar cheese, sweet potato pie, peanut butter, and bacon flavor compositions.

The polymeric foam precursor, such as a copolymer of an alpha olefin and an ester of a mono-unsaturated carboxylic acid, a foaming agent (an agent that releases gas to created void spaces within the polymer), a flavor emulsion of the type described previously, and colors are added to the mixing machine. Step 1004. For the polymeric foam body toys, the amount of the emulsion added in step 1004 by weight of the toy is from about 1.5 to about 4.0 percent, preferably from about 2.0 to about 3.5 percent, and more preferably from about 2.5 to about 3.0 percent. The amount of the flavor composition by weight of the toy is from about 0.045 to about 3.0 percent, preferably from about 0.10 to about 2.5 percent, and more preferably from about 0.15 to about 2.2 percent by weight.

In step 1006 the mixing machine is run for a mixing time tₘᵢₓ₁ at the mixing temperature Tₘᵢₓ₁ to distribute the flavor emulsion throughout the polymeric foam precursor. In certain examples, the mixing temperature Tₘᵢₓ₁ is from about 80° C. to about 110° C., preferably from about 85° C. to about 105° C., more preferably from about 90° C. to 100° C. In one example using BASF V6110M EVA, the mixing temperature Tₘᵢₓ₁ is about 95° C.

The mixing time tₘᵢₓ₁ is from about 3 minutes to about 13 minutes, preferably from about 5 minutes to about 11 minutes, and more preferably from about 6 minutes to about 10 minutes. In one example using BASF V6110M EVA the mixing time is about 8 minutes.

The mixing step of 1006 yields a flavor composition-incorporated polymer. The next step is to shape the flavor composition-incorporated polymer into the desired toy shape. In certain examples, this is carried out by first converting the flavor composition incorporated polymer into pellets which may then be transported to the site of an injection molding machine. Thus, in FIG. 10, the flavor composition incorporated polymer is pelletized in step 1008 by adding the composition to a pellet making machine for a pelletizing time tₚₑₗₗₑₜ at a pelletizing temperature Tₚₑₗₗₑₜ. The pelletizing temperature Tₚₑₗₗₑₜ ranges from 65° C. to about 95° C., preferably from about 70° C. to about 90° C., and more preferably from about 75° C. to about 85° C. The pelletizing time tₚₑₗₗₑₜ ranges from about 2 minutes to about 6 minutes, preferably from about 3 minutes to about 5 minutes, and more preferably from about 3.5 minutes to about 4.5 minutes.

Various molding processes may be used, but injection molding is preferred. The injection molding machine includes a mold that defines the shape of the toy being molded, e.g., the shape of crunch ball 20 in FIG. 1, bounce ball 36 in FIG. 2 or pebble chew 46 in FIG. 3A in 3B. Thus, in step 1010 the temperature of a temperature controlled injection molding machine is set to an injection molding temperature T_{mold1}. The injection molding is carried out for a molding time t_{mold1} which represents the time to melt and inject the flavor composition incorporated polymer into the mold and complete the molding process. In certain examples, the molding temperature is from about 140° C. to about 180° C., preferably from about 150° C. to about 175° C., and more preferably from about 160° C. to about 170° C. The molding time is preferably from about 12 minutes to about 24 minutes, more preferably from about 14 minutes to about 22 minutes, and even more preferably from about 16 minutes to about 20 minutes. In one example using BASF V6110M EVA and a flavor emulsion loading of 3.5% by weight of the toy, the molding temperature of 165° C. is carried out for about 18 minutes.

In another variation on the method of FIG. 10, the polymeric foam precursor, foaming agent, and color may be mixed and pelletized without the flavor composition in steps 1004-1008. In that case, the flavor emulsion may be added to the pellets in the injection molding machine in step 1012. After molding is complete, the toys may be removed from the molds and allowed to volatilize any foaming gases that are generated by the foaming agent. In carrying out the method of FIG. 10, the flash point of the flavor emulsion is preferably such that when the polymer used to form the toy is combined with the flavor emulsion, a homogeneous system is obtained that is able to withstand the elevated temperatures and processing times of the various processing steps used to make the toy. As the foregoing indicates, such elevated temperatures and processing times are at least 165° C. for a period of at least 10 minutes or longer.

Referring to FIGS. 4-6, elastomeric animal toys 62, 74, and 88 are depicted. Like the toys in FIGS. 1-5C, toys formed from elastomers may be solid or hollow. Each toy 62, 74, and 88 comprises a non-toxic polymeric body 64, 75, 90 having a flavor composition of the type described previously distributed therein. The amount of flavor composition in the toys 62, 74, and 88 is selected to give off a human detectable flavor scent from the toy prior to the toy being bitten or otherwise disrupted and is preferably tailored to the composition of the non-toxic polymeric body. As with the polymeric foam toys, the elastomeric animal toys 62, 74, and 88 preferably comprise a flavor composition that is incorporated in the polymer as an emulsified system with a flash point that allows the flavor composition to withstand the processing temperatures used to form the toy. The flash point of the flavor emulsion is preferably such that when the polymer used to form the outer layer is combined with the flavor emulsion, a homogeneous system is obtained that is able to withstand the elevated temperatures and processing times used to make the layer. In examples herein, such elevated temperatures and processing times are at least 165° C. for a period of at least 10 minutes or longer

In contrast to the examples of FIGS. 1-3B, non-toxic polymeric bodies 64, 75, and 90 of animal toys 62, 74, and 88 comprise an elastomer, and in particular, dual layers of elastomers with different hardnesses. The elastomer is formed from a base polymer and a vulcanizing agent. In preferred examples, the elastomer comprises a natural rubber latex. One suitable commercially available rubber is RSS-3 (“Ribbed Smoked Sheets, Grade 3”) supplied by Lien Anh Production Rubber Co., Ltd. of Vietnam. The rubber is preferably combined with a vulcanizing agent in a concentration sufficient to yield the desired physical properties, such as Shore A hardness. In certain examples, when preparing the toy, the vulcanizing agent is added in an amount of from about 0.5 to about 2.5 PHR (pounds of vulcanizing agent per hundred pounds of rubber), preferably from about 0.8 to about 2.2 PHR, and more preferably from about 1.5 to about 2.0 PHR. Preferred vulcanizing agents include sulfur compounds. One suitable commercially available vulcanizing agent is 4,4′-DTDM-80, an 80 percent (by weight) dispersion of 4,4′-Dithiodimorpholine with 20 percent (by weight) polymer binder (EPDM/EVM) and a dispersing agent). 4,4′-DTDM-80 is a free sulfur donor under normal curing conditions that leads to mon and di-sulfur cross-links with excellent eat aging properties. The recommended dosage of 4,4′ DTDM 80 is 1.0 to 2.0 PHR.

In certain examples, accelerators and/or auxiliary accelerators may also be used to speed up the vulcanization process. If used, the accelerator is preferably added in an amount ranging from about 0.1 PHR to about 3.0 PHR, preferably from about 0.2 PHR to about 2.6 PHR, and more preferably from about 0.4 to about 2.0 PHR. One suitable commercial accelerator is n-tert-butyl-2-benzothiazole sulfonamide. Suitable auxiliary accelerators include tetramethylthiuram monosulfide, which if used is preferably present in an amount ranging from about 0.1 to about 0.6 PHR, preferably from about 0.13 PHR to about 0.55 PHR, and more preferably from about 0.15 to about 0.5 PHR.

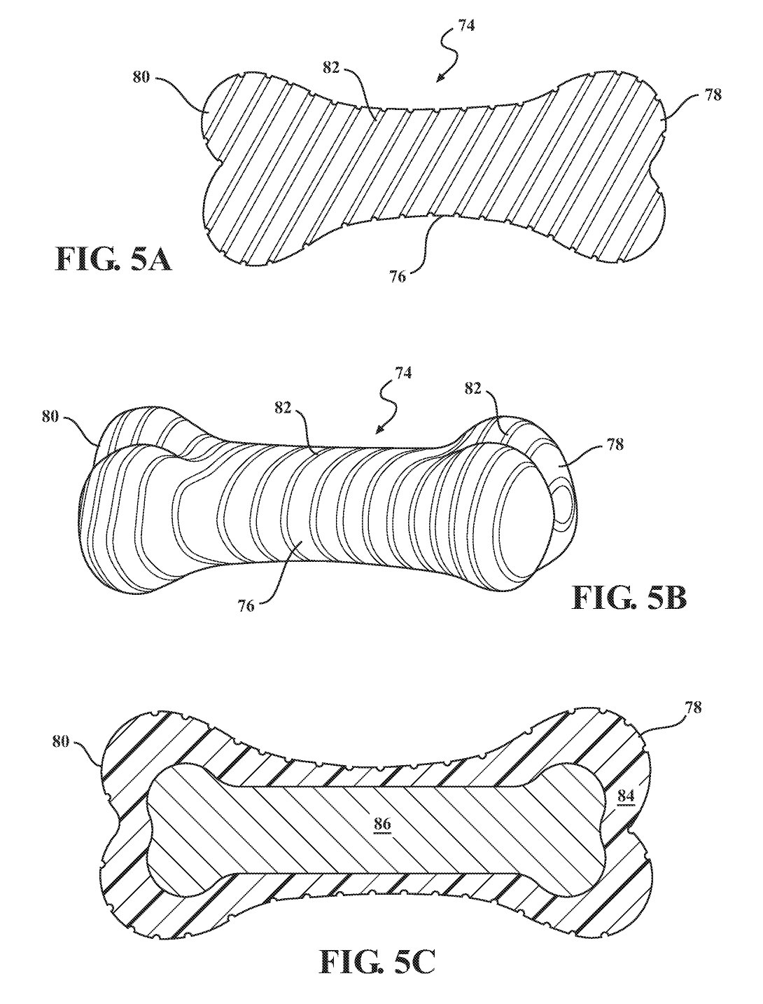

In certain examples, the rubber animal toys described herein are dual layer rubber animal toys that have a rubber core and a rubber outer layer of different hardnesses. In one implementation, a softer outer layer and harder inner layer are used. However, dual layer designs need not be used, and an exemplary single layer design will be discussed with reference to FIG. 6 (below). In certain examples, the rubber animal toys have a core Shore A hardness ranging from about 50 durometer to about 75 durometer, preferably from about 55 durometer to about 70 durometer, and more preferably from about 60 durometer to about 65 durometer. In accordance with such examples, the rubber animal toys have an outer layer Shore A hardness of from about 35 durometer to about 60 durometer, preferably from about 40 durometer to about 55 durometer, and more preferably from about 45 durometer to about 50 durometer.

In accordance with examples of dual layer rubber toys described herein, the outer layer preferably comprises a flavor compound that is added during the mixing of the outer layer components in an amount based on the weight of the outer layer that ranges from about 0.01 percent to about 2.3 percent, preferably from about 0.04 percent to about 1.9 percent, and more preferably from about 0.08 percent to about 1.8 percent. On the basis of the toy including the core and the outer layer (where the core is devoid of the flavor compound), the percentage of the flavor compound that is added during the mixing of the outer layer components by weight of the toy (i.e., including the outer layer and the core) ranges from about 0.001 to about 1.1 percent, preferably from about 0.004 to 0.95 percent, and more preferably from about 0.008 to about 0.9 percent.

In examples of dual layer rubber toys described herein, beef, peanut butter, cheddar cheese, sweet potato pie, bacon, and chicken flavors are preferably provided as flavor emulsions comprising a solvent, and in the case of beef, cheddar cheese, sweet potato pie, bacon, and peanut butter, also a separate emulsifier. For the beef, sweet potato pie, cheddar cheese, bacon, peanut butter, and chicken flavors, the percent by weight of the flavor emulsion added during the mixing of the outer layer components by weight of the outer layer components ranges from about 0.5 to about 3.0 percent, preferably from about 1.0 to about 2.7 percent, and more preferably from about 1.5 to about 2.5 percent. For each of the same flavors, on the basis of the toy including the core and the outer layer (where the core is devoid of the flavor compound), the percentage of the emulsion added during the mixing of the outer layer components by weight of the toy ranges about 0.05 to about 1.5 percent, preferably from about 0.1 to about 1.9 percent, and more preferably from about 0.15 to about 1.3 percent.

In the case of beef flavor composition, the amount of flavor compound added during the mixing of the outer layer components by weight of the outer layer ranges from about 0.015 to about 0.6 percent, preferably from about 0.05 to about 0.46 percent, and more preferably from about 0.09 to about 0.38 percent. In the case of sweet potato pie flavor composition, the amount of flavor compound added during the mixing of the outer layer components by weight of the outer layer ranges from about 0.025 to about 0.45, preferably from about 0.06 to 0.38, and more preferably from about 0.12 to about 0.33.

In the case of bacon flavor, the amount of bacon flavor compound added during the mixing of the outer layer components by weight of the outer layer ranges from about 0.06 to about 0.78 percent, preferably from about 0.15 to about 0.65 percent, and more preferably from about 0.26 to about 0.55 percent. In the case of peanut butter, the amount of peanut butter flavor compound added during the mixing of the outer layer components by weight of the outer layer ranges from 0.10 percent to about 1.08 percent, preferably from about 0.22 percent to about 0.86 percent, and more preferably from about 0.36 percent to about 0.73 percent. In the case of cheddar cheese flavor, the amount of the cheddar cheese flavor compound added during the mixing of the outer layer components by weight of the outer layer components is from about 0.31 percent to about 2.0 percent, preferably from about 0.62 percent to about 1.8 percent, and more preferably from about 0.93 percent to about 1.7 percent.

In an example, the flavor emulsions (including exemplary, preferred, and more preferred amounts) described above for use in making polymeric foam toys are also used for making the outer layer of dual rubber layer toys, albeit perhaps with different concentrations of the emulsions in the toy. It has been surprisingly found that the flavor emulsions described above for use in polymeric foam toys also provide a suitable flash point for rubber processing, which allows the same flavor emulsion to be used to provide two different polymeric toys with significantly different polymer compositions. In another example, the beef, bacon, peanut butter, cheddar cheese, and sweet potato pie flavor emulsions described above for use in polymeric foam toys are also used to make the outer layer of a dual layer rubber toy. However, the chicken flavor emulsion used or dual layer rubber toys preferably comprises a chicken flavor composition in an amount by weight of the emulsion that ranges from about 2 to about 15 percent by weight, preferably from about 4 percent to about 12 percent by weight, and more preferably from about 5 to about 10 percent by weight. As a percentage of the outer layer weight, the chicken flavor composition comprises about 0.01 percent to about 0.45 percent, preferably from about 0.04 percent to about 0.32 percent, and more preferably from about 0.08 percent to about 0.25 percent. As a percentage of the total toy weight, the chicken flavor composition is present in an amount ranging from about 0.001 to about 0.23 percent, preferably from about 0.004 percent to about 0.16 percent, and more preferably from about 0.008 percent to about 0.12 percent. In the same or other examples, the chicken flavor emulsion comprises a solvent comprising medium chain triglycerides in an amount ranging from about 80 to about 99 percent, preferably from about 85 to about 96 percent, and more preferably from about 86 to about 94 percent. In certain examples, a separate emulsifier is not used.

Preferred solvents include carboxylic acid ester triglycerides. Suitable examples of such carboxylic acid triglycerides include medium chain triglycerides and triacetin. In certain examples herein, the flavor emulsions comprising beef, chicken, sweet potato, cheddar cheese, and peanut butter flavor compositions comprise a solvent that comprises one or more medium chain triglycerides. When used as a solvent in the emulsions herein, the MCTs are present in the flavor emulsion in amounts by weight of the emulsion of at least about 20 percent, preferably at least about 25 percent, and most preferably, at least about 30 percent.

In certain examples of dual layer, rubber animal toys described herein, the core comprises from about 10 to about 50 percent by weight of the toy, preferably from about 12 to about 45 percent by weight of the toy, and more preferably from about 14 to about 38 percent by weight of the toy. In accordance with such examples, the flavor compound is provided exclusively in the outer layer, and the core is devoid of it.

Referring to FIG. 4, an animal toy 62 shaped like a ring is depicted. Animal toy 62 includes a non-toxic polymeric body 64 having an incorporated flavor composition. The flavor composition is preferably selected from the group consisting of a beef flavor composition, a chicken flavor composition, a sweet potato pie flavor composition, a peanut butter flavor composition, a cheddar cheese flavor composition and a bacon flavor composition and is present in an amount that gives off a human-detectable flavor scent from the toy 62 prior to any chewing or other disruption of the toy.

The toy 62 has a surface 65, and a plurality of sets of treads 66, 68, and 70. Each tread in each set of treads projects away from outer layer surface 65 along an axial direction (i.e., perpendicular to the radial direction of the ring). The toy 62 is shaped to include a central opening 72. A core is also provided but is not visible. In preferred examples, the flavor composition is provided as a flavor emulsion of the type described previously for dual layer rubber toys. The flavor emulsion is mixed in with the polymeric body ingredients prior to mixing. In certain preferred examples, the flavor emulsion is provided only in the outer layer comprising surface 65 and not in the core. The non-toxic polymeric body is preferably an elastomer, and in certain preferred examples is formed from a natural rubber. One suitable rubber is RSS-3, described above. The core preferably has a shore A hardness that is higher than the outer layer. The core has a shore hardness of ranging from about 50 durometer to about 75 durometer, preferably from about 55 durometer to about 70 durometer, and more preferably from about 60 durometer to about 65 durometer. The outer layer that includes surface 65 has a Shore A hardness ranging from about 35 durometer to about 60 durometer, preferably from about 40 durometer to about 55 durometer, and more preferably from about 45 durometer to about 50 durometer.

Referring to FIGS. 5A-5C, an animal toy 74 in the shape of a bone is depicted. Animal toy 74 includes a first end 78, a second end 80, and a central portion 76 which connects first end 78 to second end 80. In the lexicon of bone anatomy, the first end 78 defines a proximal epiphysis of the bone, the second end 80 defines a distal epiphysis of the bone, and the central portion 76 defines a diaphysis of the bone.

The animal toy 74 comprises a core 86 (FIG. 5C) and an outer layer 84. The outer layer 84 has an outer surface that comprises a plurality of grooves 82 that encircle the toy 84 along its lengthwise axis of the toy 74. The grooves are generally oriented at a non-orthogonal angle relative to the lengthwise axis. The shape of the bone toy 74 and the grooves 82 allow dogs to hold the toy more securely for better play and engagement. The core 86 has a Shore A hardness of ranging from about 50 durometer to about 75 durometer, preferably from about 55 durometer to about 70 durometer, and more preferably from about 60 durometer to about 65 durometer. The outer layer 76 has a Shore A hardness ranging from about 35 durometer to about 60 durometer, preferably from about 40 durometer to about 55 durometer, and more preferably from about 45 durometer to about 50 durometer.

In the case of animal toy 62 and 74, the amount of flavor emulsion in the outer layer by weight of the outer layer where chicken flavor is used is from about 1 to about 3 percent, preferably from about 1.5 to about 2.5 percent, and more preferably from about 1.8 percent to about 2.2 percent.

Referring to FIG. 11, a method of making the dual layer animal toys of FIGS. 4 and 5A-5C will now be described. In step 1020 the elastomer used to form the core of the toy is mixed with the vulcanizing agent (and any accelerators or auxiliary accelerators, if provided) at a mixing temperature Tₘᵢₓ₂ for a mixing time of tₘᵢₓ₂. The concentration of vulcanizing agent in step 1020 C_{V1} is adjusted based on the desired Shore A hardness of the core. The mixing time tₘᵢₓ₂ ranges from about 2 minutes to about 12 minutes, preferably from about 2 minutes to about 10 minutes, and more preferably from about 5 minutes to about 8 minutes. The mixing temperature Tₘᵢₓ₂ ranges from about 120° C. to about 175° C., more preferably from about 125° C. to about 170° C., and more preferably from about 135° C. to about 160° C. In step 1022 the mixture is flattened using a roller assembly. Although flattening is used as an exemplary process, other techniques may be used to distribute the additives in the base, rubber polymer.

In step 1023 the mixture is combined with a color compound and mixed again at a mixing temperature Tₘᵢₓ₃ for a mixing time tₘᵢₓ₃ ranging from about 0.8 minutes to about 3.2 minutes, preferably from about 1.0 minutes to about 3.0 minutes, and more preferably from about 1.5 minutes to about 2.5 minutes. The mixing temperature Tₘᵢₓ₃ is preferably from about 60° C. to about 90° C. preferably from about 65° C. to about 85° C., and more preferably from about 70° C. to about 80° C. The mixture may then be flattened again in step 1024.

As part of or instead of step 1024, the mixture is preferably cooled for a period ranging from about 4 hours to about 10 hours, preferably from about 5 hours to about 9 hours, and more preferably from about 6 hours to about 8 hours. The cooling temperature ranges from about 10° C. to about 30° C., preferably from about 12° C. to about 28° C., and more preferably from about 15° C. to about 25° C.

In step 1025 the mixture is molded for a molding time t_{mold2} at a molding temperature T_{mold2}. The molding time may vary with the amount of flavor composition used and with the size of the toy. In certain examples, it ranges from about 6 minutes to about 15 minutes, preferably from about 7 minutes to about 14 minutes, and more preferably from about 8 minutes to about 11 minutes. The molding temperature T_{mold2} ranges from about 120° C. to about 200° C., preferably from about 130° C. to about 190° C., and still more preferably from about 135° C. to about 180° C. The molding process is preferably rubber compression molding.

Step 1025 yields a core section of an animal toy such as the cores described for the animal toys 62 and 74 of FIGS. 4 and 5A-5C.

In step 1026 the outer layer formation begins. An elastomer (which may be the same base elastomer used for the core, such as an RSS-3 natural rubber) is again mixed with the vulcanizing agent (and any accelerators or auxiliary accelerators, if provided) for the mixing time tₘᵢₓ₂ at the mixing temperature tₘᵢₓ₂ of step 1020. In step 1026 the concentration of the vulcanizing agent C_{V2} will be less than in step 1022 in order to yield a softer durometer outer layer relative to the core. The mixture is flattened using a roller assembly in step 1028.

In step 1030 the color compound and the flavor emulsion is mixed with the flattened product of step 1028. The amounts of the flavor emulsion for beef, chicken, and bacon flavors are described above. The flavor emulsion (or mixture in the case of bacon) is of the type described previously with the flavor compound being tailored to the natural rubber and the concentration being selected to yield a desired human-detectable scent before the toy is bitten or otherwise disrupted. The mixing is carried out for the mixing time tₘᵢₓ₃ at the temperature Tₘᵢₓ₃ (described above) in step 1030. The mixture is again flattened in step 1031.

In step 1032 the outer layer is molded over the core layer, such as by using the same rubber compression molding process used to form the core. The molding temperature T_{mold3} is, in certain examples, the same as the molding temperature T_{mold2} used to make the core. In such cases, t_{mold3} is generally greater than t_{mold2} because the core will be exposed to the molding conditions of the overmold (but not vice-versa). In certain examples, t_{mold3} ranges from about 10 minutes to about 24 minutes, preferably from about 12 minutes to about 22 minutes, and more preferably from about 14 minutes to about 20 minutes. The process yields an outer layer with a hardness H2 that is less than the hardness H1 of the core, as well as an incorporated flavor compound that is located exclusively in the outer layer and not in the core. In carrying out the method of FIG. 11, the flash point of the flavor emulsion is preferably such that when the polymer used to form the outer layer is combined with the flavor emulsion, a homogeneous system is obtained that is able to withstand the elevated temperatures and processing times used to make the layer. As the foregoing indicates, such elevated temperatures and processing times are at least 165° C. for a period of at least 10 minutes or longer.

Referring to FIG. 6 an animal toy 88 shaped like a tennis ball is depicted. The animal toy 88 includes a non-toxic polymeric body 90 having an incorporated flavor composition. A stripe 92 is painted on the body 90, and the body 90 may also be molded to create a slight groove for the stripe 92. In certain examples, animal toy 88 comprises a single layer of an elastomer and is not solid throughout. Toy 88 may or may not include an animal engaging squeaker. Natural rubbers are preferred. RSS-3 is a suitable commercially available natural rubber. The flavor compositions are preferably incorporated as emulsified systems, and preferred flavor emulsions for beef, chicken, bacon, cheddar cheese, sweet potato pie, and peanut butter are those described previously with respect to dual layer rubber toys, such as those depicted in FIGS. 4 and 5A-5C.

The elastomer preferably has flavor composition incorporated in it at a concentration that gives off a human-detectable scent when before the toy 88 is bitten by an animal or otherwise disrupted. In certain examples, the flavor compositions are beef, chicken, peanut butter, cheddar cheese, sweet potato pie, or bacon flavor compositions and are tailored for use with the elastomer used to form the polymeric body 90.

The amount of the flavor composition used in forming animal toy 88 as a percentage by weight of the toy ranges from about 0.01 to about 2.3, preferably from about 0.04 to about 1.8, and more preferably from about 0.08 to about 1.4. The amount of the flavor emulsion used in forming animal toy 88 as a percentage by weight of the toy ranges from about 0.5 percent to about 3.0 percent, preferably from about 1.0 percent to about 2.5 percent, and more preferably from about 1.5 percent to about 2.0 percent.

When bacon flavors are used, the bacon flavor may be provided as a standard emulsion in which the continuous phase is a solvent such as medium chain triglycerides or as a reverse emulsion in which the flavor composition is the continuous phase, and the solvent (e.g., triacetin) is the dispersed phase.

The animal toy 88 may have any number of different diameters, and different diameters will suit different sized pets. Further, the wall thickness of animal toy 88 is preferably selected to prevent piercing by the animal. In certain examples, the animal toy 88 has a diameter of from about 1.5 inches to about 4 inches, preferably from about 1.8 inches to about 3 inches, and more preferably from about 2 inches to about 2.5 inches. At the same time, the animal toy 88 has a wall thickness that ranges from about 4 mm to about 8 mm, preferably from about 5 mm to about 7 mm, and more preferably from about 5.5 mm to about 6.5 mm. The animal toy 88 has a Shore A hardness ranging from about 40 durometer to about 60 durometer, preferably from about 45 durometer to about 55 durometer, and more preferably from about 48 durometer to about 52 durometer.

A method of making the single layer tennis ball animal toy 88 will now be described. The process is similar to that of FIG. 11 except that only one set of mixing steps is used, and injection molding is used in lieu of rubber compression molding. Thus, steps 1026 to 1031 are carried out with the vulcanization agent concentration CV2 being adjusted to obtain the desired Shore A hardness for animal toy 88. Injection molding is used in step 1032 in lieu of rubber compression molding. The amounts of each flavor emulsion added during the mixing step are described above. The molding temperatures and times may depend on the size of the ball and its thickness. However, in certain examples, the molding temperatures will be the same as those used in the dual layer toys, but the molding times will range from about 4 minutes to about 10 minutes, preferably from about 5 minutes to about 9 minutes, and more preferably from about 6 minutes to about 8 minutes.

In accordance with another aspect of the present disclosure, an animal toy is provided which comprises a plurality of non-toxic, polymeric fibers. The fibers are preferably semi-crystalline, polymeric, non-toxic fibers and are more preferably selected from the group consisting of polyesters and polyamides. Suitable polyesters include polyethylene terephthalate and polybutylene terephthalate. Suitable amides include poly(hexamethylene adipamide). The fibers may be braided. The animal toy has a flavor composition adhered to and/or incorporated in the fibers. In certain examples, the animal toys comprise a core formed from a first type of semi-crystalline, polymeric fibers, and an outer section formed from a second type of semi-crystalline, polymeric fibers. In other examples, the animal toys comprise a core formed from a first type of polyethylene terephthalate (PET) fibers and an outer section formed from a second type of PET fibers.

In accordance with such examples, the outer section fibers preferably have a greater wicking capability than the core section fibers. As used herein, “greater wicking capability” means a greater capability to move aqueous solutions along the lengthwise axis of a fiber. The core may be wholly or partly scented or unscented, and the outer section may be wholly or partly scented or unscented. The core and/or outer fibers may be coated and/or shaped to promote wicking or may be uncoated and unshaped (cylindrical). The core may be twisted or braided. In certain applications, a twisted or braided core is beneficial for increasing the strength of the toy. In a preferred example, the animal toy comprises trilobal fibers. In a more preferred example, the animal toy consists of trilobal fibers. In a still more preferred example, the animal toy consists of a core of trilobal PET fibers and an outer section of trilobal PET fibers.

In accordance with another aspect, an animal toy comprised of non-toxic polymeric fibers with a flavor composition incorporated in and/or adhered to the fibers is provided. In certain examples, the flavor composition is provided as an emulsified flavor system which is combined with a softener to define a liquid bath into which the fibers are immersed to pick-up the flavor emulsion compositions.

In general, greater wicking capability may be provided by increasing the fiber wettability and/or shaping them so they are not merely cylindrical. In certain examples, a trilobal shape is preferred. Wettability defines the degree to which a fiber will wet. If a drop spreads out indefinitely and the contact angle approaches 0°, then total wetting is occurring. In most cases, however, the drop will bead up and only partial wetting (or non-wetting) will occur. The extent to which a fiber will wet can be quantified by measuring the contact angle. The contact angle can be measured by producing a drop of pure liquid on a fiber. The angle formed between the fiber/liquid interface and the liquid/vapor (atmosphere) interface and which has a vertex where the three interfaces meet is referred to as the contact angle. Fibers may be coated to alter their surface energy, and as a result, their wettability. One suitable commercially available type of PET fiber which may be used for the outer section of PET fibers is Unifi REPREVE® PET fiber which has a coating (Sorbtek) that increases wettability. The wicking feature helps keep the toy dry after exposure to animal saliva. In the same or other examples, the core PET fibers (which are not coated or shaped to promote wicking) are supplied by Zhejiang Materials Industry Chemical Group, Ltd. of Hangzhou, China.

In one implementation, a flavor composition is incorporated and/or adhered in both the core and outer section fibers. In another implementation, a flavor composition is incorporated and/or adhered in the core fibers but not the outer section fibers. In yet another implementation, a flavor composition is incorporated and/or adhered in a portion of the core fibers and all of the outer section fibers. For example, the flavor composition may be incorporated and/or adhered in half (by weight) of the core fibers and in all of the outer section fibers.

In certain examples, a cheddar cheese flavor composition or a sweet potato pie flavor composition is incorporated and/or adhered in the semi-crystalline, polymer fibers used to form the animal toy by immersing all of the core and outer section fibers in a solution comprising a flavor emulsion and a softener. In other examples, a beef flavor composition or a chicken flavor composition is incorporated and/or adhered in the semi-crystalline, polymer fibers used to form the animal toy by immersing a portion of the core fibers and all of the outer section fibers in a solution comprising a flavor emulsion and a softener.

The flavor composition is preferably provided in the form of the same flavor emulsions described above for polymeric foam toys, with the chicken flavor emulsion described above with respect to dual and single layer rubber toys being preferred to the chicken flavor emulsion described above with respect to polymeric foam toys. The amount of the flavor emulsion added to a softener/flavor emulsion solution in which the core fibers are immersed as a percentage by weight of the core PET fibers is from about 0.6 percent to about 1.9 percent, preferably from about 0.8 percent to about 1.7 percent, and more preferably from about 1.0 percent to about 1.5 percent. The core fibers are preferably braided and the outer fibers are braided around and over them. In certain examples of animal toys comprising peanut butter or cheddar cheese flavor compositions, all of the core and outer section fibers are immersed in a solution of flavor emulsion and softener in which the amount of flavor emulsion by weight is from about 0.6 percent to about 1.9 percent, preferably from about 0.8 percent to about 1.7 percent, and more preferably from about 1.0 percent to about 1.5 percent. In certain-examples of animal toys comprising beef or chicken flavor compositions, all of the outer section fibers and half of the core fibers (by weight) are immersed in a solution of flavor emulsion and softener in which the amount of flavor emulsion by weight is from about 0.6 percent to about 1.9 percent, preferably from about 0.8 percent to about 1.7 percent, and more preferably from about 1.0 percent to about 1.5 percent. In certain-examples of animal toys comprising beef or chicken flavor compositions, all of the outer section fibers and half of the core fibers (by weight) are immersed in such a solution.

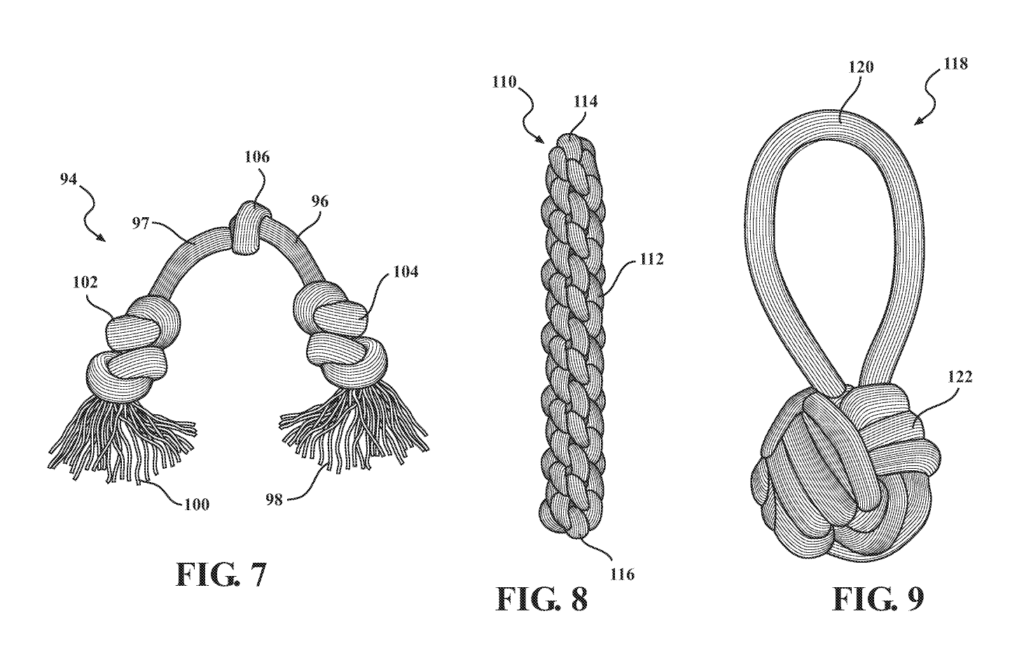

Referring to FIGS. 7-9, three animal toys 94, 110, and 118 which comprise non-toxic, semi-crystalline polymeric fibers with an adhered and/or incorporated flavor composition are depicted. In certain examples, the outer fibers have greater wicking capability than the core fibers. For example, the outer fibers may be shaped to provide greater wicking capability such as when the outer fibers are trilobal, and the core fibers are cylindrical. Each toy 94, 110, and 110 is preferably non-toxic in its entirety.

FIG. 7 depicts a tug toy 94 which is designed as a braided rope with first and second fringed ends 98 and 100, each of which have adjacent knotted sections 104 and 102. A central knot 106 is spaced apart from the knotted sections 104 and 102 by unknotted connecting sections 96 and 97, respectively. Although not visible, tug toy 94 includes a core section in which a flavor emulsion is adhered and/or incorporated in all or part of the core fibers and all of the outer section fibers. In certain examples, the outer section of the tug toy includes no flavor composition.

Referring to FIG. 8, a rope stick 110 is depicted. A flavor emulsion of the type described above with respect to the polymeric foam toys is adhered to and/or incorporated in all or part of the core fibers and all of the outer section fibers. Rope stick 110 has a first end 114, and a second end 116, spaced apart by the body 112 of the rope stick 110.

Referring to FIG. 9 a “monkey fist” 118 is shown which comprises a loop 120 and a knot 122. The monkey first 118 is comprised of an inner core of PET fibers and an outer section of PET fibers, wherein the core fibers have an incorporated and/or adhered flavor composition (preferably provided as a flavor emulsion), and the outer fibers have a greater wicking capability than the core fibers.

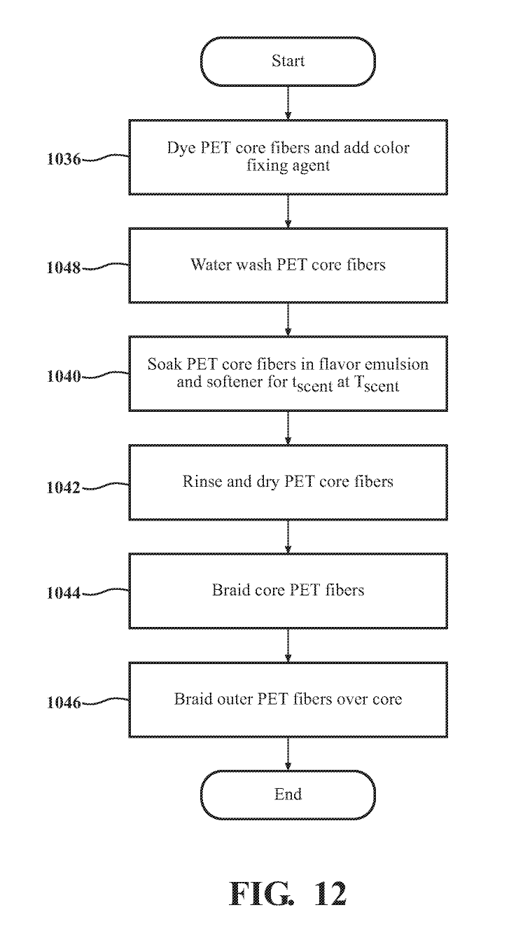

Referring to FIG. 12 a method of making the braided fiber animal toys of FIGS. 7-9 is depicted. In step 1036 a spool of core PET fibers is provided. In step 1036 the core fibers are immersed in a dye to which a color fixing agent is added. The process is carried out a temperature of from about 120° C. to about 140°, preferably from about 125° C. to about 135° C., and more preferably from about 129° C. to about 131° C. for a period of from about 0.5 hour to about 1.5 hour, preferably from about 0.7 hour to about 1.3 hours, and more preferably from about 0.9 hour to 1.1 hours.

In step 1038 the core fibers are washed repeatedly in water at a temperature of from about 40° C. to about 60° C., preferably from about 45° C. to about 55° C., and more preferably from about 48° C. to about 52° C. All or part of the core fibers are then immersed in a volume of the flavor emulsion and a softener at a temperature ranging from about 50° C. to about 70° C., preferably from about 55° C. to about 65° C., and more preferably from about 58° C. to about 62° C. for a period of from about 0.2 hour to about 1.2 hour, preferably from about 0.5 hour to about 1.0 hour, and more preferably from about 0.7 hour to about 0.8 hour. The amount of flavor emulsion in the volume of flavor emulsion and softener by weight of the core PET fibers ranges from about 0.6 percent to about 1.9 percent, preferably from about 0.8 percent to about 1.7 percent, and more preferably from about 1.0 percent to about 1.5 percent. The amount of softener (by weight) relative to the amount of food favor emulsion is from about 0.5:1 to about 3:1, preferably from about 0.8:1 to about 2.5:1, and more preferably from about 1.8:1 to about 2.2:1. Step 1040. Preferred softeners include silicone softeners, and more preferred softeners include cycloaliphatic epoxy silicones, such as (EpoxycyclohexylethylMethylsiloxane)-Dimethylsiloxane copolymers (CAS No. 67762-95-2).

The amount of fiber (by weight) immersed in the flavor emulsion/softener solution is from about 0.03 percent to about 0.17 percent, preferably from about 0.05 percent to about 0.15 percent, and more preferably from about 0.08 percent to about 0.12 percent.

The fibers are then rinsed and dried. Step 1042. After drying, the fibers (along with any unflavored fibers) are braided to form the core. Step 1044. The outer section fibers are also prepared in accordance with steps 1036-1044. The fibers forming the outer section, are then braided over the core in step 1046.

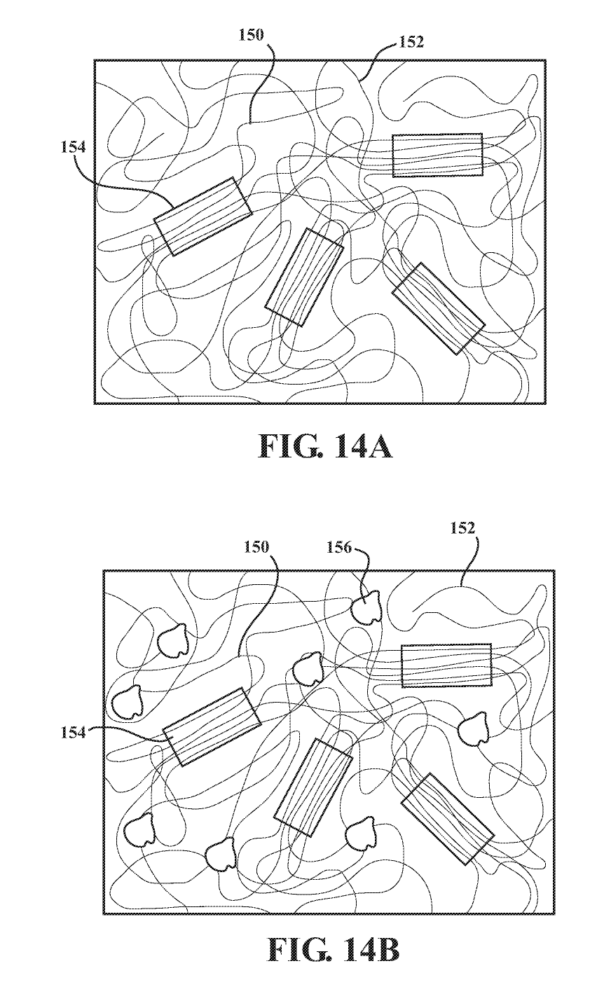

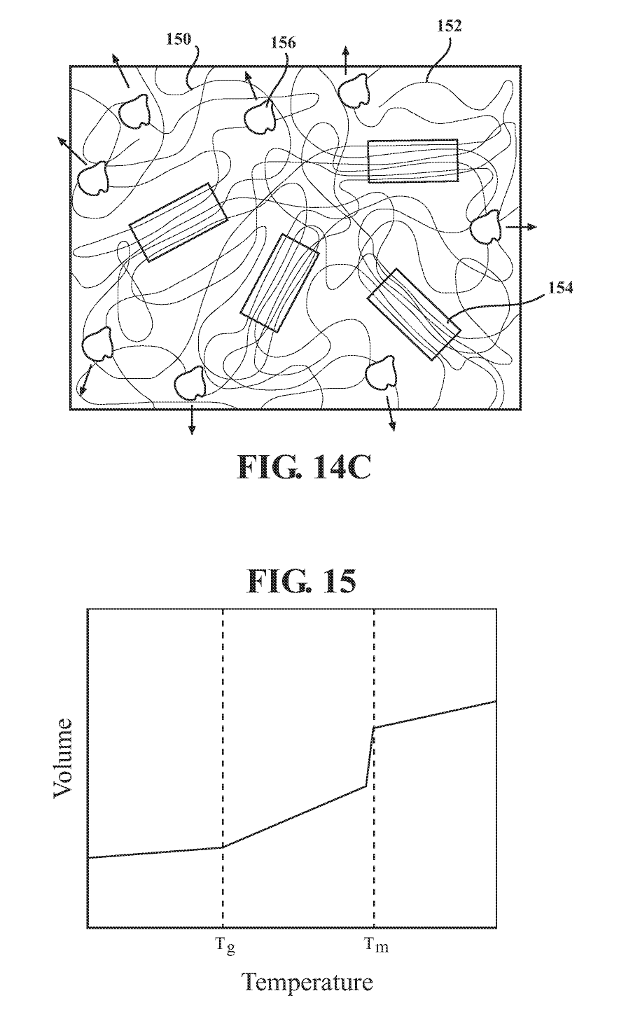

The temperature of the flavor emulsion/softener solution is preferably greater than the glass transition temperature and less than the melting point of the semi-crystalline fibers comprising the animal toy. Without wishing to be bound by any theory, it is believed that in this temperature range, the flavor compounds have increased dispersal within the fibers without disrupting the structural integrity of the fibers because of an increase in free volume, as illustrated in FIG. 15. FIGS. 14A-14C depict the fibers during the addition of the flavor compounds. In FIG. 14A, the fibers are above their glass transition temperature and no flavor compounds have been added. The semi-crystalline fibers 150 comprise an amorphous section 152 and structured sections 154. In FIG. 14B the semi-crystalline fibers have been immersed in the solution of flavor emulsion and softener at a temperature between the glass transition temperature and the melting point. Thus, flavor molecules 156 have distributed throughout the amorphous region 152 of the semi-crystalline fibers 150. In FIG. 14C the fibers have cooled down to below their glass transition temperature, which reduces the movement and diffusion of the flavor molecules within the amorphous region 152 of semi-crystalline fibers 150.

Without wishing to be bound by any theory, it is also believed that the use of a softener at the foregoing temperatures causes the flavor emulsion to be absorbed into the PET fibers instead of merely adhering to the surface thereof, although some amount may adhere as well.

The foregoing descriptions of specific embodiments have been presented for purposes of illustration and description. They are not intended to be exhaustive or to limit the invention to the precise forms disclosed. Many modifications and variations are possible in light of the above teachings, with modifications and variations suited to the particular use contemplated.

What is claimed is:

1. An animal toy, comprising:
a non-toxic polymeric body having a flavor composition incorporated therein.

2. The animal toy of claim 1, wherein the flavor composition is a food flavor composition.

3. The animal toy of claim 1, wherein the polymeric body comprises a polymeric matrix, and the flavor composition is incorporated in the polymeric matrix.

4. The animal toy of claim 1, wherein the flavor composition consists of one or more AAFCO compliant ingredients.

5. The animal toy of claim 1, wherein the flavor composition consists of one or more FEMA GRAS ingredients.

6. The animal toy of claim 1, wherein the flavor composition is emulsified.

7. The animal toy of claim 1, wherein the non-toxic polymeric body comprises an elastomer.

8. The animal toy of claim 1, wherein the non-toxic polymeric body comprises a foam.

9. The animal toy of claim 1, wherein the flavor composition is an emulsion having a flash point of at least about 80° C.

10. A method of making an animal toy having a shape, the method comprising:
providing a non-toxic polymer;
mixing the non-toxic polymer with a flavor composition to yield a flavor composition-incorporated polymer;
molding the flavor composition-incorporated polymer using a mold that defines the shape of the animal toy.

11. The method of claim 10, wherein the step of mixing the non-toxic polymeric a flavor composition comprises mixing the non-toxic polymer with an emulsion comprising the flavor composition.

12. The method of claim 11, wherein the emulsion has a flash point of at least about 80° C.

13. A method of making an animal toy, comprising:
providing non-toxic, semi-crystalline, polymeric fibers;
immersing the non-toxic, semi-crystalline, polymeric fibers into a liquid medium comprising a flavor composition; and
braiding the non-toxic, semi-crystalline, polymeric fibers.

14. The method of claim 13, wherein the fibers are coated and/or shaped to promote wicking.

15. The method of claim 14, wherein the liquid medium comprises a softener and a flavor emulsion, and the flavor emulsion comprises the flavor composition.

16. The method of claim 15, wherein the flavor emulsion has a flash point of at least about 80° C.

17. An animal toy comprising a plurality of non-toxic, braided, semi-crystalline polymeric fibers, wherein the non-toxic, braided, semi-crystalline polymeric fibers include a flavor composition.

18. The animal toy of claim 17, wherein the non-toxic braided fibers are coated and/or shaped to promote wicking.

19. The animal toy of claim 17, wherein the flavor composition consists of one or more AAFCO compliant ingredients.

20. The animal toy of claim 17, wherein the flavor composition consists of one or more FEMA GRAS ingredients.

21. The animal toy of claim 17, wherein the flavor composition is emulsified.

22. The animal toy of claim 21, wherein the emulsified flavor composition has a flash point of at least about 80° C.
